(19) United States
(12) Patent Application Publication
(10) Pub. No.: US 2009/0200720 A1
(43) Pub. Date: Aug. 13, 2009

(54) ONDULAR WASHER

(76) Inventor: Lothar Brückner, Leonberg (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/306,420

(22) PCT Filed: Jun. 21, 2007
(86) PCT No.: PCT/EP07/56193

§ 371 Date: Dec. 23, 2008

(30) Foreign Application Priority Data
Jun. 27, 2006 (DE) 2006 029 411.4

(51) Int. Cl. F16F 1/32

(52) U.S. Cl. 267/162

(57) ABSTRACT

An axial ondular washer made from a circularly annular, flat spring material having an ondular line with maxima and minima with respect to a centre plane, wherein these maxima and minima are defined as lying on different sides of the centre plane and in each case being tangent on a plane of a first or second abutment (1, 2), which plane extends parallel to the centre plane, is to be improved with regard to its initial compression behaviour. For this purpose, an ondular washer of this type is characterized by the following features: the ondular line is composed of consecutive first and second sections, of which at least in each case two sections exist; in a first section, there is at least one ondular longitudinal region which begins and ends in the centre plane (3) and has a maximum and a minimum; in a second section, there are at least two ondular peaks having maxima or minima and elevations which lie below the spacing dimension between the delimiting planes of the abutments (1) and (2), wherein each adjacent first section is adjoined directly in each case by one of said ondular peaks.

The invention relates to an ondular washer according to the preamble to claim 1.

Such ondular washers are known in varying designs, specifically from EP 1 477 701 A2 and WO 2005/005855 A1, among other publications. In these known ondular washers, a spring characteristic curve can be achieved in an initial area of a spring compression range of the washer, in which the spring characteristic curve runs significantly flatter than in an area of the washer path that follows the respective initial area. This is achieved by a wave progression in which increasingly more ondular peaks at the frontal abutments of the ondular washers continually or incrementally engaged in the abutment area in the initial area of the spring compression range, meaning that they introduce forces.

The invention deals with the problem of using a suitable arrangement of high and low waves in a circularly annular, flat spring material to generate a spring characteristic curve in which the flat initial and ensuring steep branches exhibit a straight-line nature, and yield a concise salient point at convergence. At the same time, the high waves are to be as uniformly distributed over the periphery of the ondular washer as possible, so that the elastic forces are also uniformly distributed over the periphery proceeding from the high waves.

For example, an arrangement of four high and eight low waves can be such that the four high waves are uniformly distributed over the periphery, i.e., arranged at a 90° distance relative to one another, with a respective two lower waves lying in between. If the middle line of all waves is here arranged on an identical plane, the high waves will behave in a less steep manner than if they were arranged directly next to each other. As a consequence, the flat branch of the characteristic curve (initial characteristic curve) only experiences a relatively low buildup of forces, and hence is still bent. There is no defined salient point here. The reason is that the run-out of the high waves can undergo deformation relatively unimpeded at the beginning of spring compression.

The situation becomes different if four high and eight low waves are arranged in such a way that a respective two adjacent, high waves lie between four low waves. At the beginning of spring compression, when only the high waves are active, they behave quasi as though the washers would only exhibit high waves. The initial characteristic curve is straight, and passes over into the steep characteristic curve range via a concise salient point. The disadvantage to this arrangement is that the high waves, if only a total of four of them can be used to achieve a predetermined spring characteristic curve, can only be situated diametrically opposite each other one time. However, applications often make a uniform peripheral distribution desirable, meaning an arrangement with peripheral distances of significantly less than 180°.

The problem according to the invention is resolved in a generic ondular washer via a design based on the characterizing features of claim 1.

Advantageous and expedient embodiments are described in the subclaims.

The invention is based on the general idea of distributing as many ondular sections with initially high spring compression stiffness as possible uniformly over the ondular washer periphery on the one hand, and supporting them against the initially less steep areas in such a way that their initially high respective spring stiffness actually remains effective over a definable spring compression path to the extent desired on the other.

Exemplary embodiments of the invention described in greater detail below are depicted in the drawing.

The drawing shows:

FIGS. 1-3 a complete winding over 360° of various ondular line progressions of an axial ondular washer.

All figures diagrammatically depict the wave progression of an ondular washer secured between a first and second abutment 1; 2, specifically over the entire periphery of 360°. In the respectively identical clamping states, no spring compression of the ondular washer has yet taken place.

In all three depicted wave progressions, four initial wave sections each with wavelength area λ are present over a complete ondular washer periphery. An ondular maximum and ondular minimum extend into ach of the wavelength areas λ on either side of a central plane 3, wherein they form a complete wavelength with measure λ. By definition, an ondular maximum is present when the respective ondular peak is tangent to the plane of the first abutment 1, while an ondular minimum is present if a ondular peak proceeding from the central plane 3 is tangent to the plane of the second abutment in terms of ondular valley.

In all embodiments shown in the three figures, the respective ondular peaks in the respective first wave sections λ are effective at the beginning of spring compression. The ondular ranges lying between the first ondular sections λ each exhibit only ondular peaks with an amplitude lying below the measured distance between the two abutments 1, 2.

Important in terms of the invention for the intermediate sections peripherally lying between the first ondular sections is the respective presence of maximums and/or minimums, which must by definition be tangent to the respective plane of the first or second abutment 1, 2. The progression of these “low” ondular sections is such that a first ondular section is followed by a respective ondular maximum or minimum. As a result of the measure cited above, the first ondular sections λ retain a nearly unchanged initial stiffness during an initial spring compression path. This applies relative to the entire, flat, desired spring characteristic curve progression up to the steep characteristic curve area, which preferably jumps suddenly at a specific salient point.

The effect according to the invention is achieved by virtue of the fact that the end areas of the ondular section λ each directly abut the respectively adjacent abutment 1, 2 via an immediately adjacent small wave, which prevents them from deflecting in a direction parallel to the central plane so as to reduce spring stiffness.

All features presented in the specification and ensuing claims can be significant to the invention, whether individually or combined with each other in whatever manner.

1. An axial ondular washer, comprising:
a circularly annular, flat spring material with an ondular line;
maximums and minimums that are included with the ondular line and are also with respect to a central plane,
a first abutment and a second abutment both running parallel to the central plane, where each of the first abutment and the second abutment include a respective plane, and the first abutment and the second abutment each include a delimiting plane where a spacing dimension is between the delimiting planes and wherein the maximums and minimums are defined as lying on varying sides of the central plane and tangent to the respective plane of one of the first abutment and the second abutment,
a consecutive first section and a consecutive second section included with the ondular line, of which at least two respective sections exist,
at least one ondular longitudinal region λ that is included with the first section, wherein the at least one ondular longitudinal region λ begins and ends in the central plane and has a maximum and a minimum;
at least two ondular peaks that are included with the second section, the at least two ondular peaks having exclusively one of maximums and minimums, and elevations lying below the spacing dimension between the delimiting planes of the first abutment and the second abutment, wherein each adjacent first section is adjoined directly by one of the at least two ondular peaks.

2. The ondular washer according to claim 1, wherein only ondular peaks including one of maximums and minimums are present in the second sections.

3. The ondular washer according to claim 2, wherein only one is selected:
i. ondular peaks with maximums, AND
ii. ondular peaks with minimums are present in all second sections.

4. The ondular washer according to claim 2, wherein ondular peaks with one of only maximums and only minimums are formed, respectively alternating from section to section.

5. The ondular washer according to claim 1, wherein ondular peaks with maximums and minimums are formed in the second ondular sections.
